(19) United States
(12) Patent Application Publication
(10) Pub. No.: US 2003/0059072 A1
(43) Pub. Date: Mar. 27, 2003

(54) Audio-cell

(76) Inventor: Sonny Lyod Chambers, Brooklyn, NY (US)

Correspondence Address: Sonny L Chambers, 573 East 79 Street, Brooklyn, NY, 11236, US

(21) Appl. No.: 10/050,193

(22) Filed: Jan. 16, 2002

Related U.S. Application Data
(60) Provisional application No. 60/281,006, filed on Apr. 4, 2001.

(51) Int. Cl. H04R 25/00

(52) U.S. Cl. 381/312

(57) ABSTRACT

A communicating apparatus, having a crossover network (47) comprising a tunable selecting means, coordinating with a volume peaking means for giving a user the option to select and boost a preferred audio setting while communicating, said crossover network is adapted for dividing and tuning at leas three band of audio frequency signals while transmitting and receiving communication.

The crossover network

wherein a band of high frequency signal, (74) a band of midrange frequency signals, (75) and a band of low frequency signals, (76) each is employed for driving an individual magnetic region. The receiving section (85) further comprising a output port adopted for coupling to an external acoustic medium, the same medium having means for connecting to an external audio system in a motor vehicle.

### BACKGROUND

1. Field of Invention

This invention relate to crossover networks, audio ports, electronic coupling mediums and electronic acoustic hearing aids, for enhancing a communicating audio section.

2. Description of Prior Art

Wireless communication are exiting new concept, but can also be harmful communicating devises. Telecommunication apparatus are used any where from a personal habitant to automobiles. Today, they are many laws passed through out the country banding telecommunication devises from motor vehicles, such as US public law 100-394, Aug. 16, 1988, requiring hand held communication devices to be coupled with an external hearing aid, because of it's potential hazard to motorist and pedestrians. Despite the danger. The handheld telecommunication apparatus have evolve to become a main source of communication. However; in order to bypass some of the occupying distractions and hazard of communicating while performing a physical task, magnetic coupling hearing aid are adopted to a communicating section to aid in communicating in an un-occupying manner.

A prior invention relating to a magnetic aid for hearing is U.S. Pat. No. 5,740,257 by Marcus; Larry Allen Apr. 14, 1998, which describes a magnetic coupling hearing aid with active noise control for eliminating noise by generating a representation of the original input signal, employed to drive an individual external earphone, position for easy access to a user. A receiving apparatus disposed into the ear cavity for signal response, and to drive a magnetic field, comprising an interior cavity and a audio output port for inputting signals to a ear cavity, having a receiver in said interior for receiving a audio signal, and transducer for communicating with said ear cavity. These plugged-in magnetic hearing aids devices, are some time manufactured with handheld telecommunication devises, and they are compatible with most telecommunication devices. Magnetic field hearing aid or headsets are used on a communication device to bypass the occupancy of an hand held telecommunication device. But, a user is still occupied with an annoying headset, plus a handheld telecommunication device while communicating, when using a magnetic coupling hearing aid with a wireless communicating device.

Unlike “Audio-Cell” wherein a coupling method execute a touch-free, hands-off, remote way of communicating. Magnetic coupling hearing aid bring on increase of body temperature while your body is active, they also cause friction, and can affect a users hearing, therefore this becomes a great negative drawback for the magnetic coupling hearing aid devices.

Most prior art in this field do not emphasize the acoustic section of a communication apparatus enough. Audio related article are not that concern with sound efficiency but there attention is directed in other areas such as recording, access dialing and voice activated access. A related article to audio sound is U.S. Pat. No. 4,537,018 by Shiramizu; Takami Aug. 27, 1985 the invention contemplate the use of variable frequency dividers, for separating the frequency of a clock pulses by a programmed input that are responsive to tones and active signals from a keyboard. A musical instrument comprising a code generator that's responsive to a operating key for generating a code indicating tone pitch, and another code indicating a active operated key. A second frequency could be preset and divide to a another count value. These frequency dividers are used in this article to detect a pitch or tone that function from a key pad and eject a band of unwanted frequency. In this article sound is produce from said keypad and not from a verbal audio system.

Although multi feature options on a wireless telecommunicating apparatus are nice to have, such as, Wireless Web, and Voice Activated-Dialing. The main key factors such as, the sound quality that's produced from a modems audio section is often overlooked, and there advantages usually rely on there capacity to hold a plurality of characteristic displays. But these different function does not give a user a clear audio signal while communicating.

Unlike the present invention “Audio-Cell” wherein audio signals are carefully divided into levels of individual band of frequencies, processing clear audio signals. communicated signal. To provide a unique coupling method. Audio signals are carefully emphasized to bring a clear band of signals in a communication apparatus. A person can communicate using a handheld communication apparatus more remotely, with little to no hazardous or harmful results.

a) Magnetic hearing aid, or headsets, coupled to a communication apparatus occupies a users hearing capacity therefore put a person at risk to any potential operating hazard.

A major advantage of the present invention “Audio-Cell” is, it's convenient no touch communicating feature, in which verbal communication can be executed more remotely.

a) One can control a wireless communication devise from a distinct audio system.

b) To give a crystal clear quality to communication enabling a user to receive and transmit communication to his or her selected preference.

c) To give motorist and civilians an option to operate a communication apparatus safely without breaking the law and govern communication to there chose.

### DRAWING FIGURES

In the drawings, closely related figures have the same numbers but different alphabetic suffixes.

FIG. 1 Show a signal flow chart illustrating a divided band of signals flowing through a entire system.

FIG. 2 show a perf-board without any components.

FIG. 3A to 3F show a Schematic diagram of band-pass filter circuits a input point, and illustrates connections.

FIG. 4A to 4G show a schematic diagram of tunable means, switches and illustrate connections.

FIG. 5A to 5H show pictorial and schematic diagrams of an integrated coupling medium.

FIG. 6A show a schematic diagrams of an amplifying section, three divided input channels, and a method of connection.

FIG. 6B show a show receiving output section and illustrates connections to a external audio port.

FIG. 6C illustrated connections from a receiving section to a displaying means.

6D illustrates connections with a receiving input section, a transmitting input section, and amplifier's out put terminals.

FIG. 7A to 7F show pictorial diagrams of exterior connections, from a communication device to a distinct reproducing audio system, located in a motor vehicle.

FIG. 8 show a schematic ruff draft of an entire constituted system.

FIG. 9 show a single channel flow chart of a entire systems signal flow.

FIG. 10A to 10B illustrates external tuning and adjusting for operation.

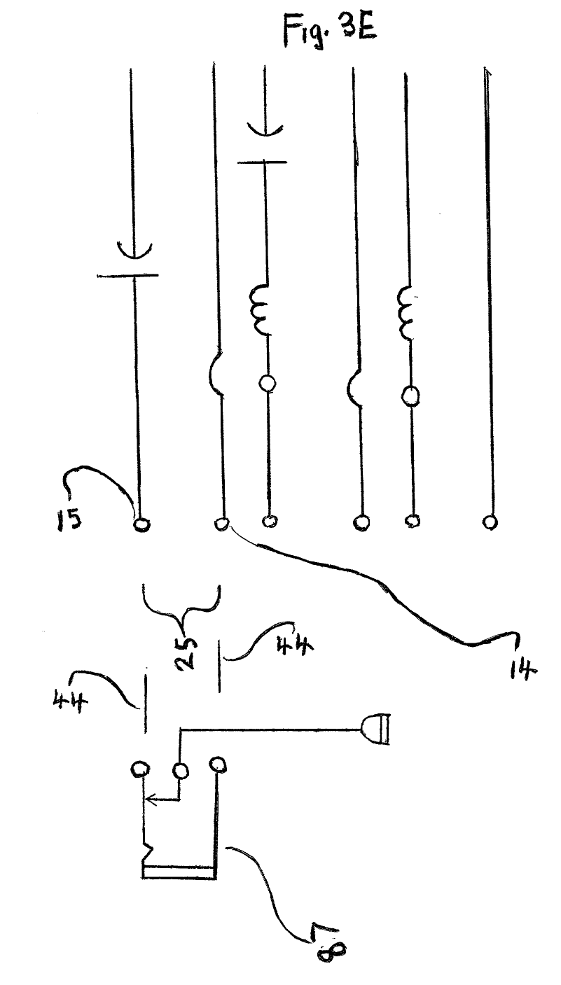

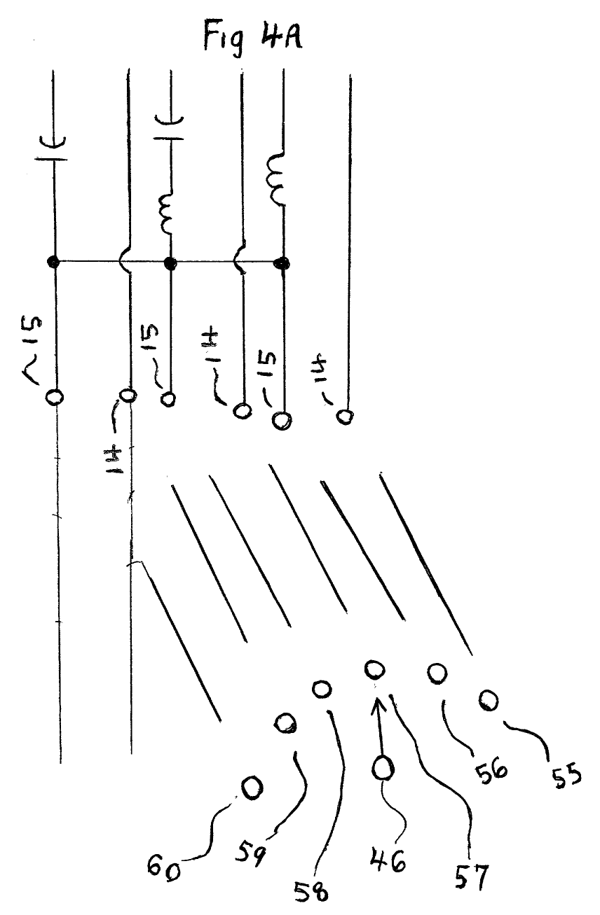

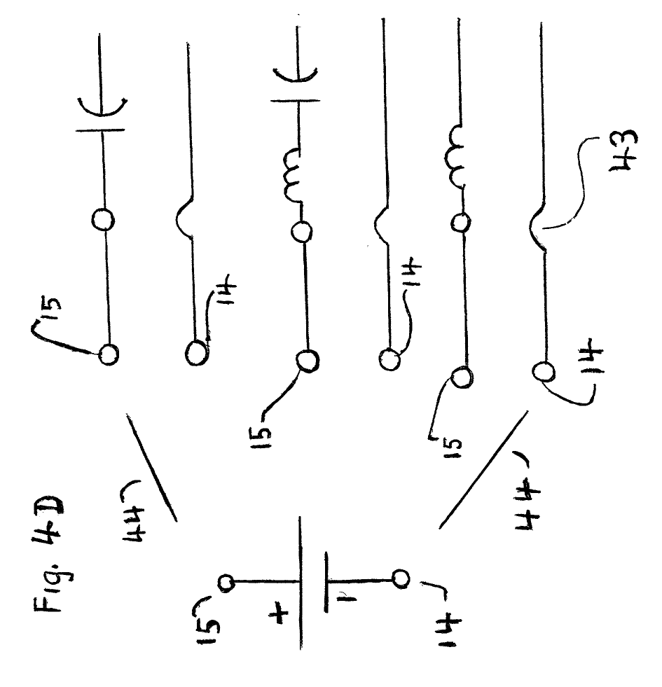

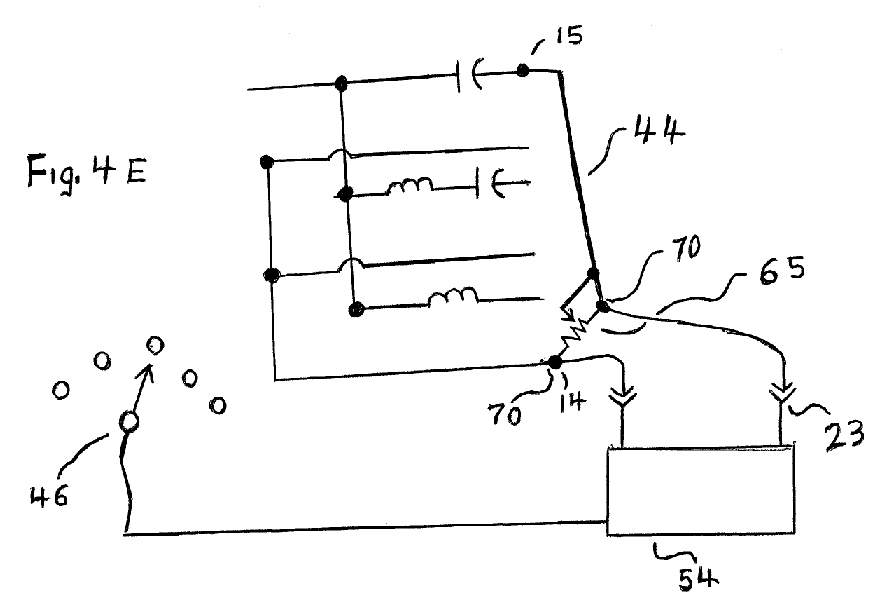

FIG. 4D illustrates a battery connection to a crossover network.

### REFERENCE NUMERAL IN DRAWINGS

11 base of filter

14 negative terminal

15 positive terminal

17 audio integrated coupling medium

18 wire conductor

20 capacitor

21 inductor

22 male connector

23 female connector

24 signal flow

25 input terminal

26 output terminal

27 displaying means

28 amplifying section

33 transistor

34 High band filter circuit

35 Low band filter circuit

36 Midrange bad filter circuit

37 Engagement

38 Tweeter

39 Midrange speaker

40 Woofer

41 communication apparatus

42 Filter circuit

43 Cross section

44 Conductor

45 Battery

46 Center pole

47 Crossover network

50 one element

51 two element

52 load resistor

53 signal flow

54 IC chip

55 Variable pole

56 Variable pole

57 Variable pole

58 variable pole

59 variable pole

60 variable pole

61 Plug

62 reproducing audio system from a motor vehicle

63 audio input from a motor vehicle's audio system

64 Vcc terminal

65 Tune resistor

66 Earth ground terminal

68 Bottom end of a communication apparatus

69 One side of a communication apparatus

70 Contact point

71 Keypad

72 The shell of a plug

74 high frequency signal

75 midrange frequency signal

76 low frequency signal

78 Volume switch

79 Top of switch

80 Bottom of switch

81 Notch

82 Knob

83 Tuner switch

84 Microphone

85 Receiving audio section

86 transmitting audio section

87 audio port

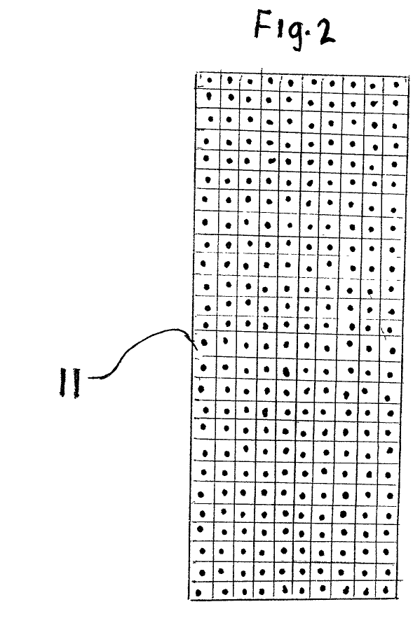

In the illustration FIG. 2 the board 11 is the base of a filter circuit. It is a thin piece of Perf-board made of a plastic material. The board is 2×2 in length and 2×2 in width. It can be miniaturized into a micro chip for a better enclosure, or it can be modified in any formation.

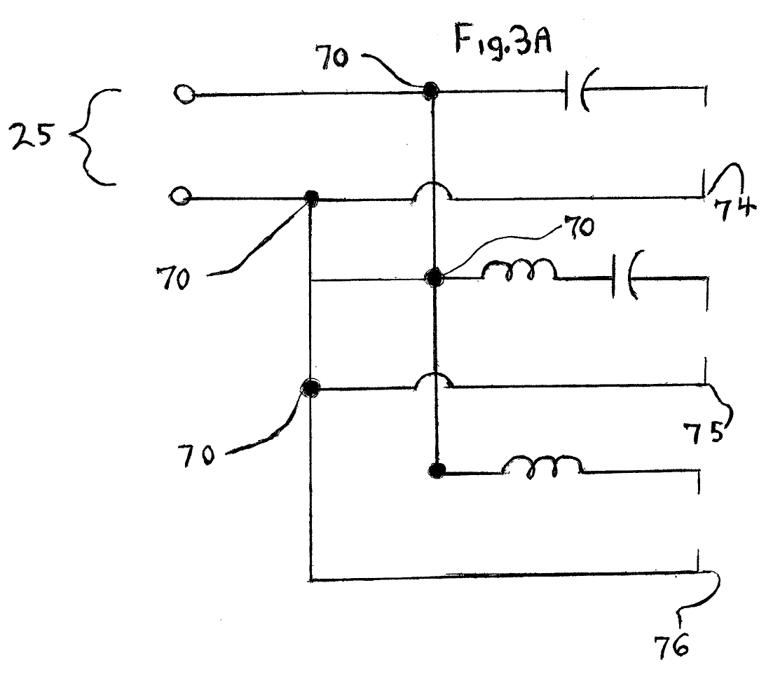

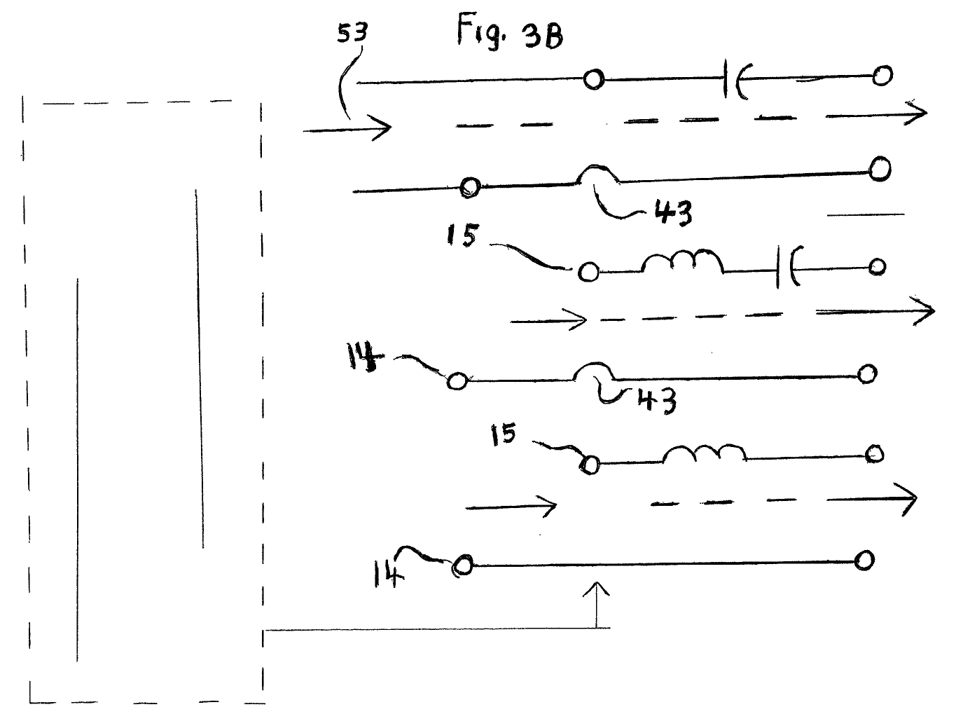

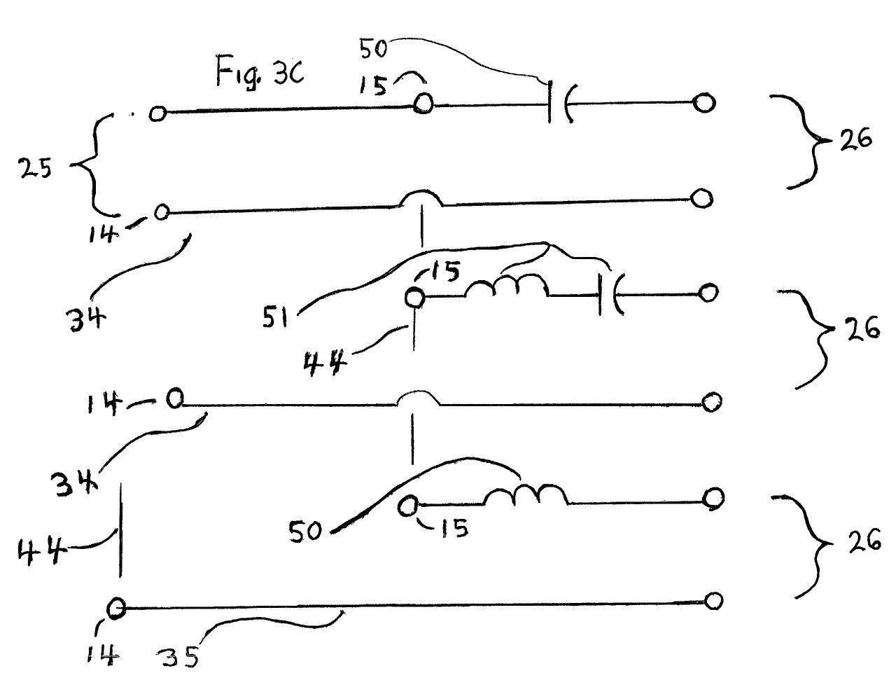

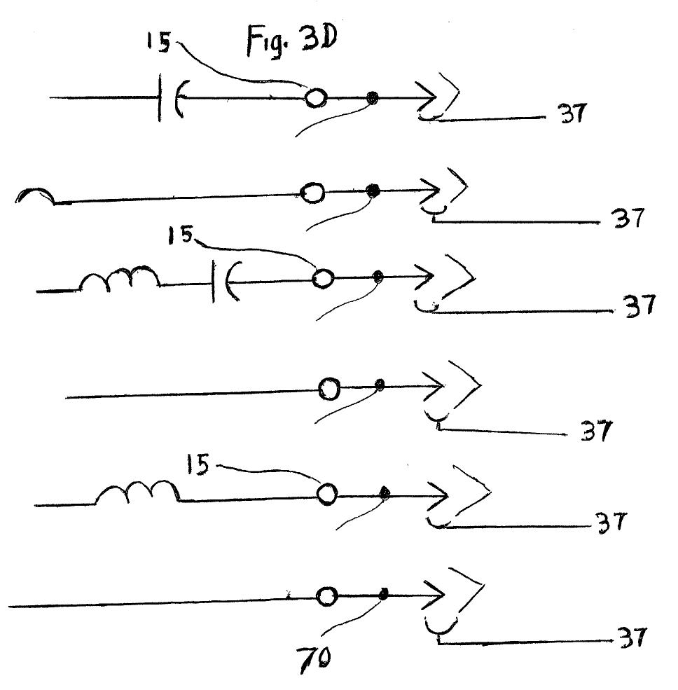

The description below illustrates a crossover network connecting to a input port coupling means, for a responding microphone input signals. FIG. 3E illustrates, a port coupling means 87 connecting to the main input 25 of a high band-pass filter circuit in a crossover network circuit. From the positive terminal 15 of a high band-pass one element filter circuit, a contact is made to a conductor 44. From the opposite end of the same conductor, a contact is made to the positive terminal 15 of a port coupling means 87. From the negative 14 terminal of the same port coupling means, a connection is made to the negative terminal of said high band pass one element filter circuit.

FIG. 11 illustrates a connection of a 5 volt battery from a communication apparatus's power sours, to a crossover network circuit. The positive terminal 15 from a one element high band-pass filter circuit is connected to a conductor. At the opposite end of said conductor, a contact is made to the positive terminal of a 5 volt battery 45. The negative terminal 14 of the same battery is connected to a conductor. From the opposite end of the same conductor, a connection is made to the negative terminal of a one element low band-pass filter circuit.

FIG. 3C show a schematic diagram of three band-pass filter circuit and illustrates the farming of a crossover network. A one element high band-pass filter circuit 34, lay adjacent to a two element 51 high band-pass series filter circuit 34. A one element low band-pass filter circuit 35, lay adjacently below both high band-pass circuits. In the illustration FIG. 3C and 3A. From one end of an inductor from a low band-pass filter circuit's positive terminal, 15 an intersection is made, crossing 43 a negative conductor 44 -of a high band-pass two element 51 circuit, and making a connection 70 at the positive terminal 15 of the same high- band-pass two element filter circuit, coming in contact with one side of a series coupled inductor 21. From the same contact 70 point, another intersection is made crossing 43 a second negative conductor 44 of a high band-pass one element 50 filter circuit, and making contact 70 at the circuits positive terminal, 15 and one side of a capacitor. From the negative terminal 14 of a low band-pass one element circuit. A connection 70 is made, to a negative conductor 44 of a high band-pass two element filter circuit. From the negative conductor connection point 70 of the same high band-pass two-element filter circuit, a second contact is made to the negative terminal 14 of a high band-pass one element filter circuit, by the main input terminals. A three way crossover network 47 is then formed, leaving a main input 25 at the high band pass one element filter circuit terminals. Output signal 26 flows 53 to the opposite side of the circuit's terminals. Illustrated in FIG. 3B, where, the low signal 76 outputs at a low band-pass one element filter circuit, the high signal 74 output at a high band-pass one element filter circuit, and the midrange signal, 75 outputs at a two element high band-pass filter circuit.

FIG. 4E show a switch, a IC chip, tunable means and peaking means, and illustrates the constitution of a unique integrated circuit. The center pole of a switch comes in contact with a MF8 timer IC chip. The diagram in FIGS. 4A to FIG. 4G and FIG. 4E illustrates connections of a switch and a IC chip. From a 5 volt positive vcc terminal 15 contact 70 is made to the center-pole 46 of a multi-position rotary switch. From a output 26 point of the IC chip, a contact 70 is made to a conductor of a male connector. The male connector engages 37 with a female connector. From the opposite end of the same female connector's conductor, 44 a contact is made to one side of a tunable resistor's 65. From the connection point 70 of the tunable resistor, a connection is made to the positive terminal 15 of a one element high band-pass filter circuit. From a one element low band-pass filter circuit, a connection is mad to the opposite side of the same tunable resistor, then to a conductor of a male connector. The male connector then engages with a female connector. The female connector's conductor then make a contact 70 to the negative 14 output terminal of the same IC chip.

FIG. 4 A illustrates a multi-position rotary switch connecting at the input of a crossover network. Horizontally to a right from the center pole 46. A variable pole 55 using a conductor, 44 makes a contact 70 to the negative input terminal 14 of a low band-pass 34 one element 50 filter circuit. From the positive terminal 15 of the same low band-pass filter circuit, a conductor makes a connection at it's opposite end to a variable pole 56 that's adjacent to pole 55. The pole that's vertically upward from the center pole 46 is pole 57. From a conductor, pole 57 makes contact with the negative terminal 14 of a high band-pass midrange 36 two element 51 filter circuit. From the positive input terminal 15 of the same two element high band-pass 34 midrange 36 filter circuit. A conductor makes contact with a variable pole adjacent to pole 57 which is pole 58. From a conductor, a pole 60 horizontally to the left from the center pole 46 makes contact to the conductor's opposite end, then to the positive input terminal 15 of a high band-pass one element 50 filter circuit. A variable pole 59 that's adjacent to pole 60, then makes contact from a conductor's end, to the negative terminal 14 of the same high band-pass one element filter circuit.

FIG. 4C consist of more than one audio channels and illustrates a connecting method, illustrating connections from a amplifier to a crossover network. The transistor elements used in the illustration shows several engagements from a crossover network circuit, to the input of an amplifier circuit.

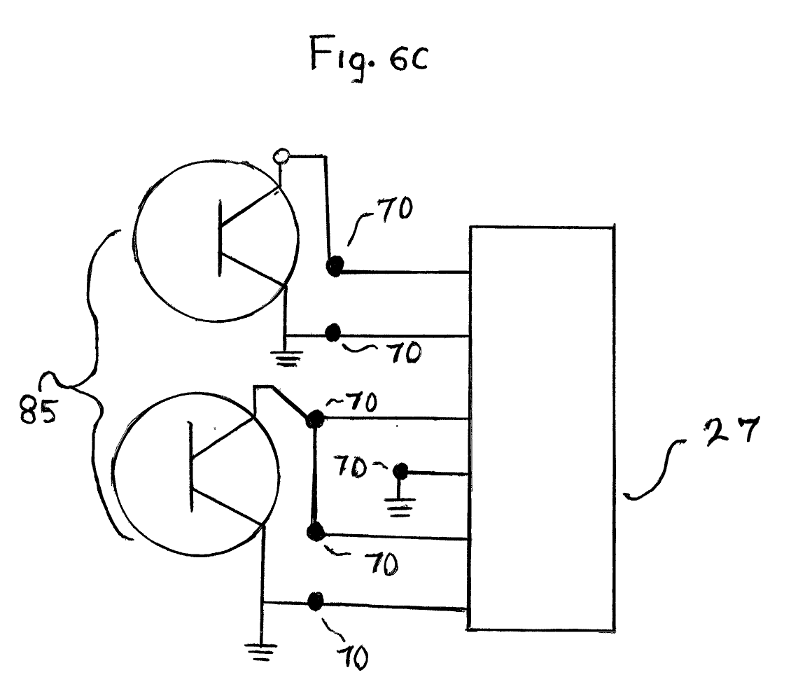

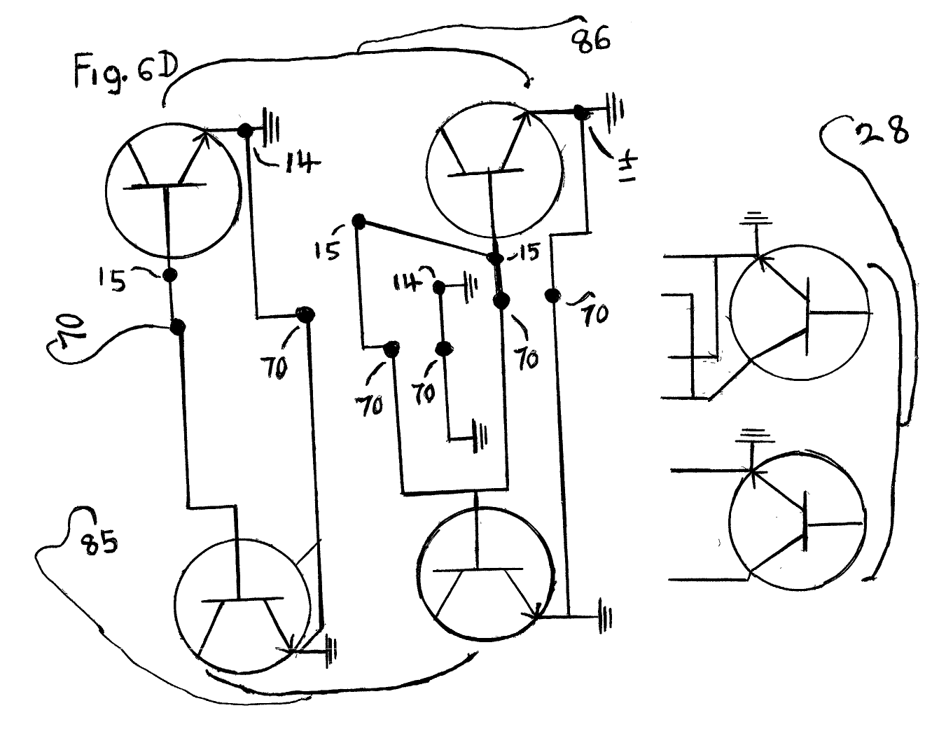

Illustrated in FIG. 6A FIG. 6C and FIG. 3D illustrates three divided channel connections from the output of a crossover network circuit, to the input of a amplifier circuit and FIG. 3C shows an input point and a output point on said crossover network circuit. From the positive 15 output terminal of a high band-pass 34 one element 50 filter circuit, contact is made to the conductor of a male connector. 22. From the same male connector, an engagement is made with a female connector 23. From a female connector's conductor, a contact is made to the positive input base terminal 15 of a transistor 33. From the input negative earth ground terminal 66 of the same transistor, a contact is made to the conductor of a female connector 23. From the same female connector an engagement is made with a male connector 22. From the same male connector's conductor, 44 a contact is made to the negative output 26 terminal 14 of a one element 50 high band-pass 34 filter circuit. From a input load resistor's 52 positive terminal, 15 a contact is made to the conductor 44 of a female connector 23. From the same male connector's conductor, 44 a contact is made at the output 26 positive terminal 15 of a two element 51 high band-pass 34 filter circuit. From the negative output terminal 14 of the same band-pass two element filter circuit. A contact is made to the conductor 44 of a male connector 22. From the same male connector, an engagement is made to a female connector 23. From the same female connector's conductor 44, a contact 70 is made at a earth ground 66 negative terminal 14 of a audio transistor 33. From a second transistor 33 of said amplifying section, a contact is made from the positive terminal 15 of a transistor, at the base input terminal, to the conductor of a female connector. From the female connector, 23 an engagement is made to a male connector 22. From the same male connector's conductor, contact is made at the positive terminal 15 of a low band-pass 35 one element 50 filter circuit. From the same low-band 34 pass one element 50 filter circuit's output negative 14 terminal, a negative connection 70 is made to the conductor 44 of a connector. From the same connector, of the low band-pass filter circuit an engagement 37 is made with another connector. From the same connector, a connection is made to a input earth ground negative terminal of the same audio amplifier's transistor.

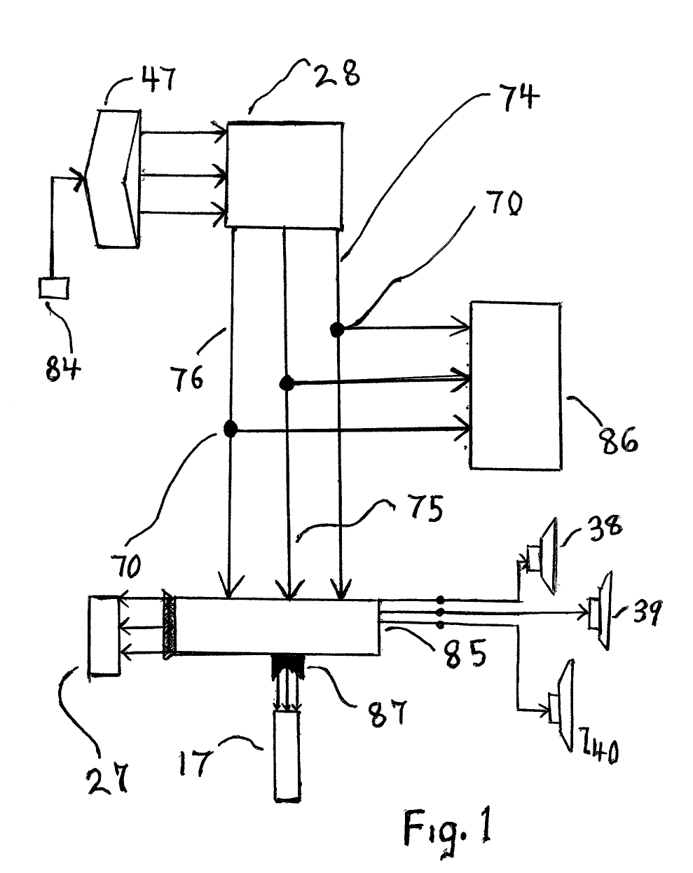

FIG. 1 illustrates a plurality of band audio signals, produced from a crossover network flowing through out the system in at least three divided channels. From a microphone 84, a plurality of signals flows to a crossover network. From a crossover network 47, at least three are less individual band of signals are injected to a audio amplifier section. From a audio amplifier 28, a high frequency range of output signals 74 is connected to the input channel of a transmitting audio section 86. From a mid-range of output signal 75 from said amplifier, a second connection is made to a second input channel of said transmitting audio section. From a low range of output signal 76, a third connection is made to a third input channel of said transmitting section.

FIG. 1 illustrates signal flows from a audio contact point to the input channels of a receiving audio section. From a high range of output frequency signals, a contact 70 is made to one channel of a receiving section. From a midrange of output signals contact point 70, a second connection is made to a second input channel of said receiving audio section. From a low-range of output signals contact point 70, a third connection is made to a third input channel of said receiving audio section. A display apparatus 27 is coupled respectively to said receiving output signals for displaying said signal's status. Said output signals is then couples to a integrated cable where it then couples with a external audio system.

FIG. 6D Shows inside connections from a amplifier to the input of a receiving section and a transmitting input section. In the description below, audio input channels are firs connection to a transmitting section. A positive input connection is made to the positive 15 base terminal of a transistor, in a transmitting audio section. A negative 14 input connection is made to the earth ground terminal 66 of the same transistor, in said audio section. A positive 15 input connection is made to the base terminal of a second transistor, in said transmitting audio section. A negative input connection is made to the earth ground 66 terminal of said second transistor. A third input connection is made to said second transistor's positive base terminal in said audio section. A input connection is made to another ground terminal of said second transistor, in said audio section.

FIG. 6D illustrates a audio input connection, from the above plurality of audio sections to a receiving section. A positive 15 input connection is made to the base terminal of a transistor, in a receiving audio section 85. A negative input connection is made to the earth ground terminal 66 of the same transistor, in said audio section. A input positive connection is made to the base terminal 15 of a second transistor. A negative input connection is made to the earth ground terminal of said second transistor. A third input connection is made to said second transistor's positive base terminal. A third connection is made to another ground terminal of said second transistor, in said receiving audio section. From a out put contact point from said receiving section, high frequency signals is connected to a tweeter 38. From a second output contact point from said receiving section, midrange frequency signals is connection to a midrange speaker 39. From a third contact point from said receiving section, low range frequency signals is connected to a woofer speaker 40.

Illustration FIG. 6B. Illustrates a connection from a receiving section to a output coupling port, adapted for external coupling. From the positive 15 collector terminal of a transistor, on a receiving section, a connection 70 is made to a series capacitor. At the opposite end of said capacitor, contact is made to the positive terminal 15 of a female port coupling means 87. From the negative terminal 14 of said port coupling means, a conductor 44 comes in contact with a earth ground terminal at the opposite end of said conductor.

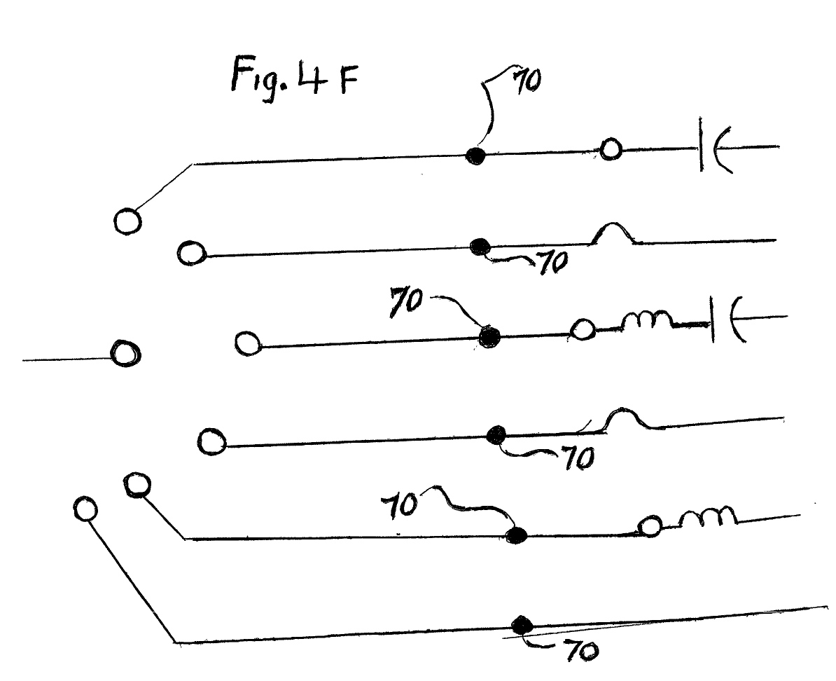

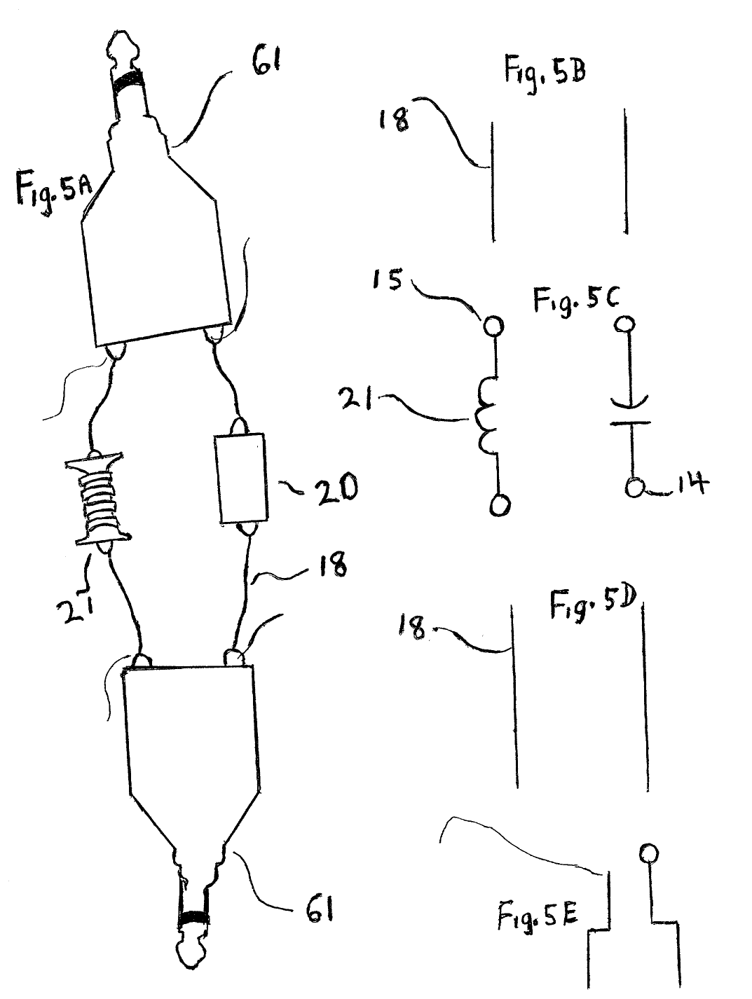

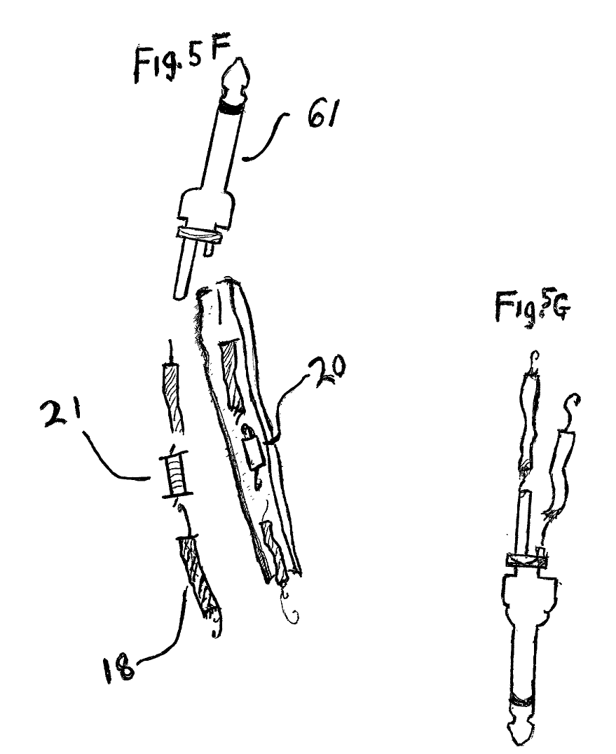

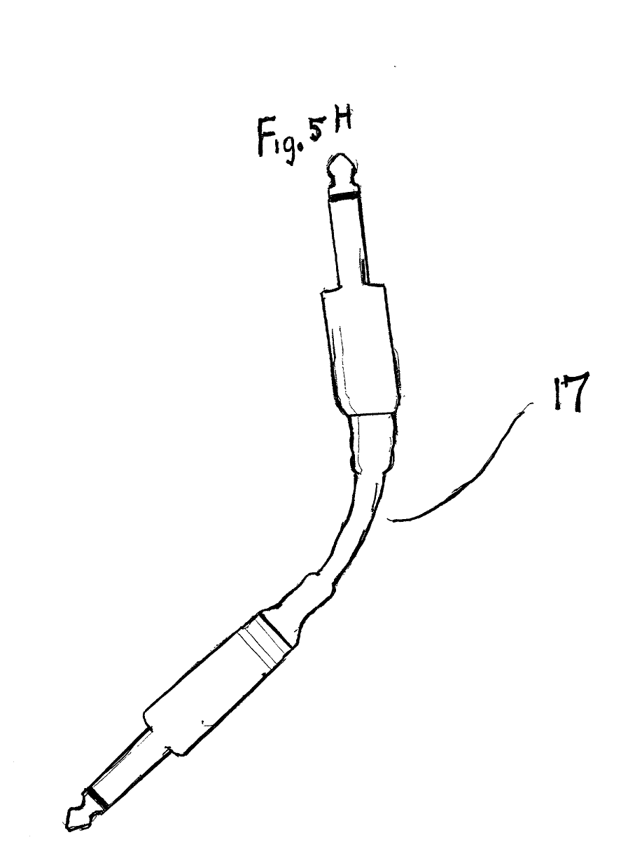

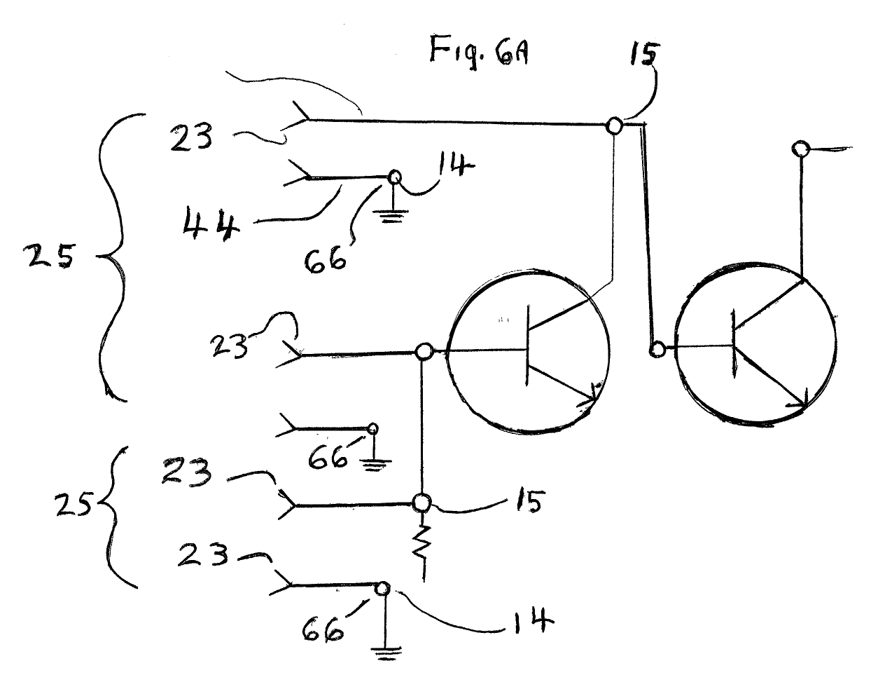

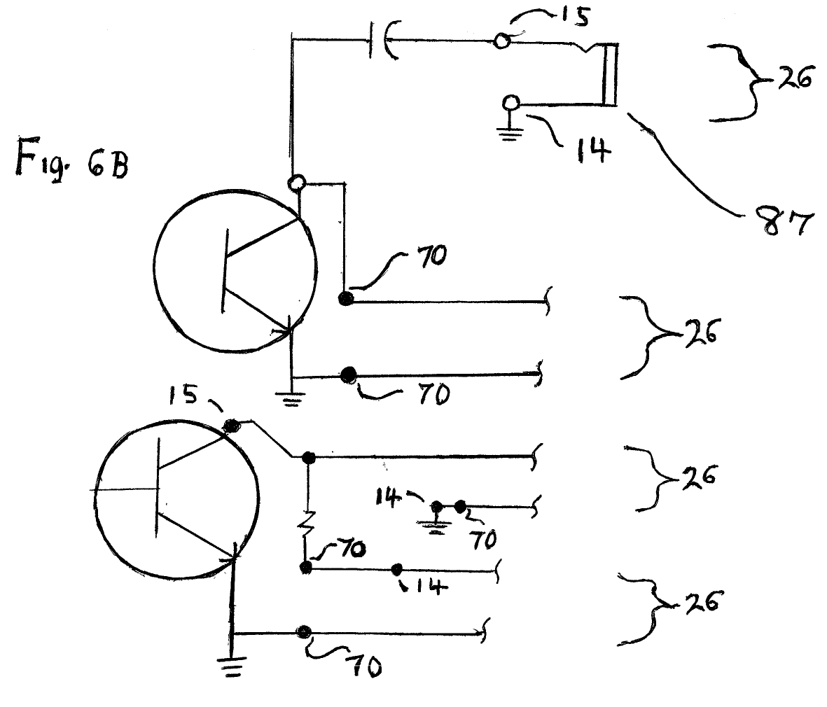

FIG. 5A to 5G. shows a audio cable comprising a integrated circuit, adopted to oppose a band of frequency, wherein a positive conductor wire is parallel to a negative conductor wire, and they both flow in a separate parallel motion, having one side of the circuit conducting low rang frequency, and the other side conducting high range frequency. The internal consist of, two wires which runs parallel until the output plug contact points. The cable also consist of two separate filter circuit, adjacent to each other. From the left side of a plug a conductor wire 18 makes contact to one end of an inductor. A second conductor wire, makes a contact from the opposite end of said inductor 21 to the left side of a second plug. From the right side of said second plug 61 a conductor wire 18 makes contact to one end of a capacitor. A second conductor, then makes contact to the opposite end of said capacitor. At the opposite end of the same conductor-wire 18, a connection is made to the right side of the first plug 61.

FIG. 8 Illustrate a ruff draft view of signal flows through out a entire system. Signal flows 53 from a microphone output 26. Horizontally to the right is a crossover network. From the microphone's output, signals are sent to a 3-way crossover network 47, which then applies input signals to a amplifier 28. Horizontally to the right of said amplifier is a audio transmitting section. Said amplified signals from the amplifier is entered into said transmitting section. Vertically to the left of the transmitting device 86 is a receiving audio section 85, where said input signals are respectively join to the input of said audio receiving section. Vertically down from said receiving section 85 is a acoustic electronic integrated medium 17, which is adopted to transport said output signals to an input port of a motor vehicle's acoustic reproducing system, where said signals are reproduced and output to at least one magnetic hearing aid.

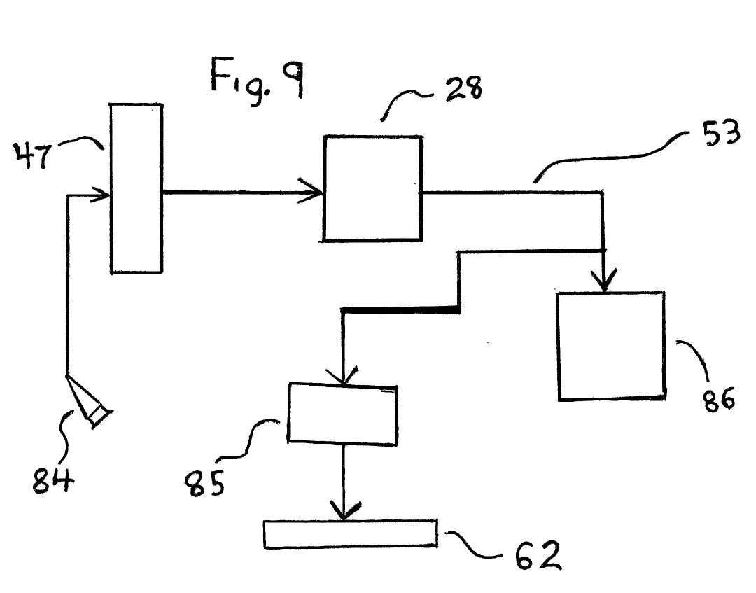

Operations FIGS. 7 to 10 and FIG. 3B

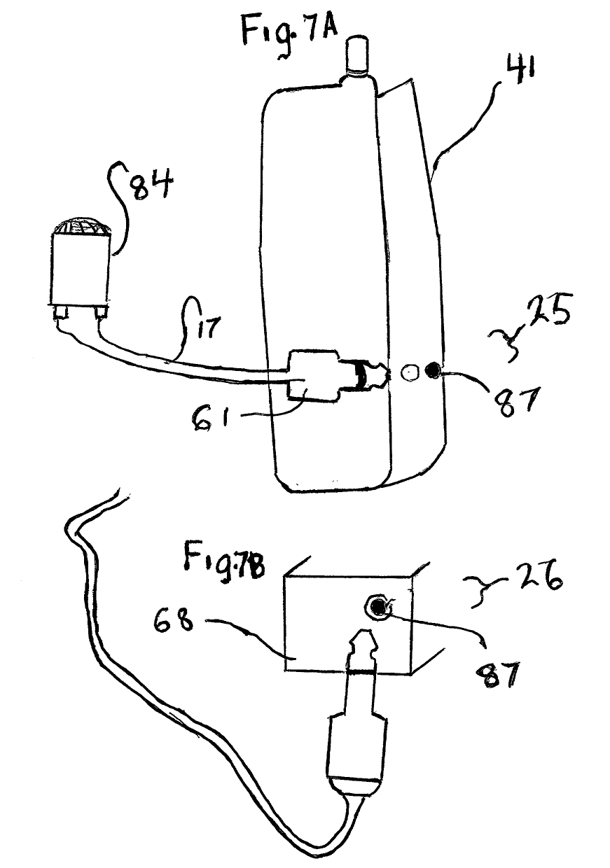

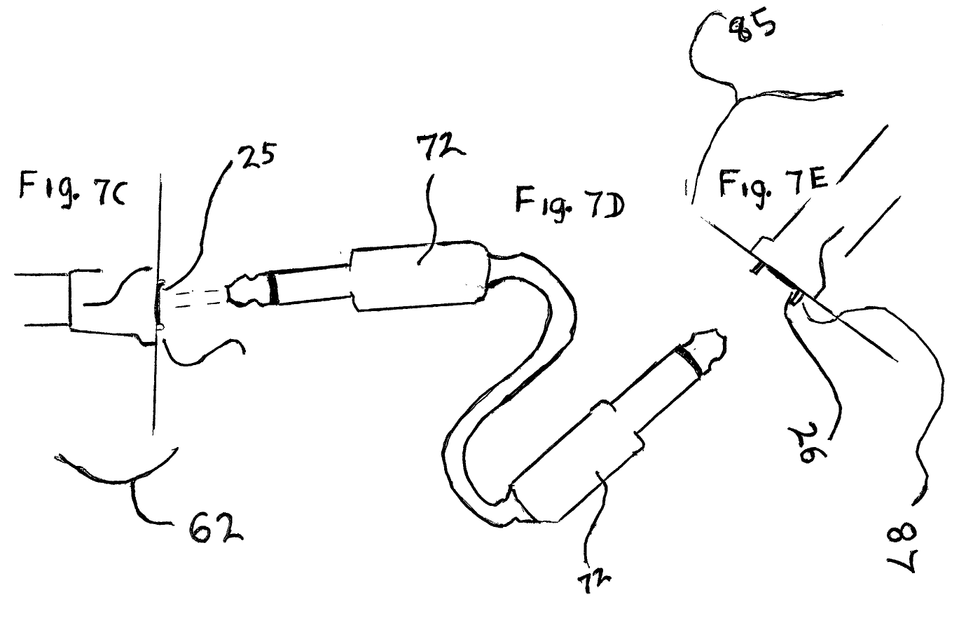

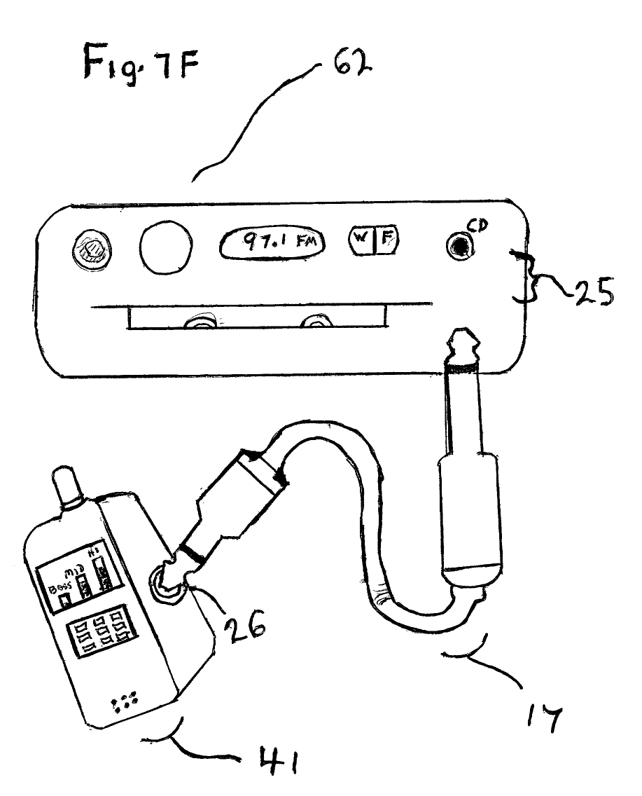

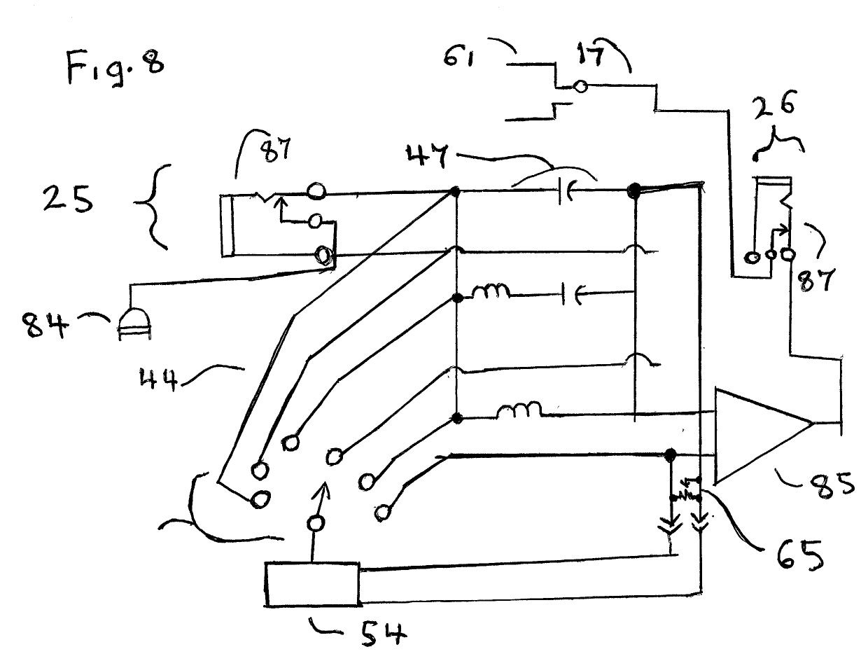

A crossover network coupled with a communication apparatus, and an integrated medium, join with a external reproducing acoustic system. One would start operating by connecting the system for operation illustrated in the pictorial view in FIG. 7A, One must first hold a microphone's coupling medium 17, griping a plug 61 by it's shell, then insert the plug into a microphone's external input 25 port 87, located on one side of a communication apparatus, as illustrated in FIG. 7A. After the microphone is in, a filtering coupling medium with a 1/8 inch plug at each end, is applied to one bottom side of a communication apparatus, gripping one end of a 1/8 inch plug's shell 72 as illustrated in FIG. 7B and FIG. 7E then insert the plug at the bottom side 68 of said communication apparatus into a female output 26 port 87 of a receiving section. At the opposite end of the same coupling medium, shown in FIG. 7C and FIG. 7F and apply a connection to the input port 25 of an external reproducing system. When the connections are through with. Press the power button on said communication apparatus to apply current signals through out the entire circuit.

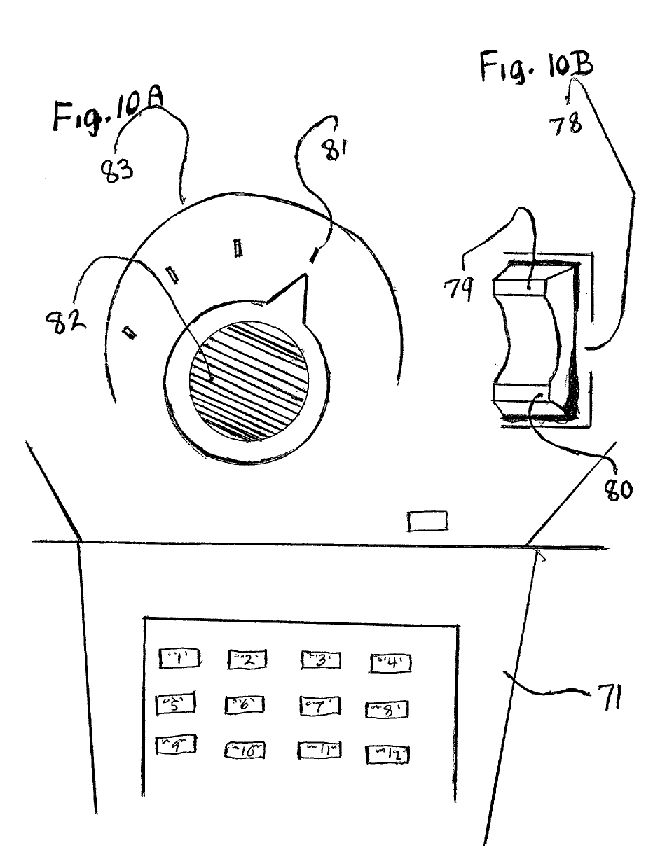

When a electronic audio function is executed, signal flow through out the system, then couples externally to an external independent reproducing system. FIGS. 3B and FIG. 1 illustrate a plurality of divided signal flowing through out the system. From a microphone out-put terminal. Input signals are applied to a three-way electronic crossover network 47. Signals are then divided into three different band of frequencies. illustrated in FIG. 3B. A high band frequency, 74 which initialize from a high pass filter circuit. A midrange band of frequency, 75 which initialize from a two element high pass filter circuit, a low band of frequency, 76 which, output from a one element low band-pass filter circuit. The three signals are then applied at the input of an amplifier, then input to a transmitting section 86 where said signals makes another input connection to the input of a receiving section. 85 The same three separate output Signal from the said receiving section, is applied to a female output port 87. When said port is coupled with a cable, signals are also transported from the telephone audio receiving section to a coupling medium 17, which, then couples to an external reproducing system and injected into a (CD) Compact disc input socket 25, where audio signals are reproduced in an external audio system. At leas three individual band of frequency signals are sent to a transmitting input section, where said signals are transmitted to a remote user at the opposite end. Sound frequency on a telecommunication apparatus is tuned by a switch means, located on a keypad 71 illustrated in FIG. 10A. One can start adjusting the frequency by selecting a band of frequency for operation. Using your hands, grip the knob 82 of a rotary switch. Twist said knob to the appropriate selected notch 81. A volume control push button switch is used to increase, or decrease the frequency selected by said rotary switch. As illustrated in Fig. 10B. Press on the top end 79 of the switch, to increase the volume of a band selected frequency. Press on the bottom end 80 of the switch, to decrease the volume of a band selected frequency.

Summary Ramifications and Scope

Accordingly one can see that a tunable crossover network having at leas three audio channels, is employed for emphasizing signals entering an amplifying means, wherein an amplifier is adopted for peaking said signals respectively inputting to a transmitting section, where said inputting signals intercept and connects to a second input of a receiving section. The receiver section further include, a output port for external coupling with a electronic coupling medium, said medium further having an integrated filter circuit to oppose a plurality of frequency. Said coupling medium is employed for coupling with a motor vehicle's reproducing acoustic system. Approximately at the same interval, the inputted signals to said transmitting section, transmit said plurality of signals to a responsive functioning means, then to a remote user on a receiving end. An acoustic coupling medium combine with a receiving section, could be used to join a motor vehicle's reproductive acoustic system with a communication apparatus. One can also see that, a crossover network enhance the common communication apparatus's audio efficiency and performance. One can also notice that, a tunable selector means, coordinating with a volume tuning means, gives one the option to select and boost an individual band of frequency, It can easily be used while operating a vehicle. The sound separation brings good audio quality. The combination of a communicating apparatus, and a external coupling medium, and an external audio system, create a remote way of communicating. A user can transmit, and receiving communication without occupying his or herself.

Furthermore advantages of the crossover network comprising means for coupling externally include that;

it eliminate the use of headphones or headsets that occupy a users hearing cause hazards;

it eliminate distortion, and bring forth a clear audio reception;

it bring forth a new way to communicate; due to the conjunction of on external system;

it execute communication in a non occupying manner and enable a touch-free way to communicate;

it bypass radioactive waves that initialize from a radio communication apparatus;

it can adjust audio frequencies to once satisfaction or once preference;

it can enable one to tune microphone input signals and microphone output signals.

It enable a user to control audio communicating signals externally, using an external audio system.

Although the description above contain many specificity's, these specific factors should not be considered as a limit to the scope of this invention but as illustrations of preferred embodiments.

A pushbutton switch could be added for selecting instead of a rotary switch. A displaying mean could be used to display the current signal status. The filter circuit can be miniaturized for a better installation closure. A plurality of tuning means could be added to the crossover network system. The crossover network could be electronic are non electronic. The receiving port could be coupled using a non integrated medium. Additional element could be added to the electronic crossover network system such as resistors, capacitors diodes, transistors and inductors for better performance. Elements in the crossover network could be coupled in parallel or in series order.

Thus the scope of this invention should be determined on the appended claims and their legal equivalent, rather than by the given examples.

I claim:

1. In a communicating audio system comprising a crossover network having tunable means for adjusting audio signals,
a) said crossover network producing a plurality of audio signals,
b) a band of high-range audio frequency signals is employed for enhancing the high range audio pitch and for driving at least one high range magnetic field,
c) a band of midrange audio frequency signals is employed for enhancing the midrange audio pitch and for driving at least one midrange magnetic field,
d) and a band of low-range audio frequency signals is employed for enhancing the low range audio pitch, and for driving at least one low range magnetic field,
e) said audio frequencies signals from said crossover network are injected respectively into a amplifier for amplifying said band of audio signals,
f) the amplified band of audio signals are injecting respectively into a audio transmitting section,
g) then make a second input from said transmitting section to a audio receiving section,
h) said audio receiving section further include a output port for externally coupling with an electronic medium,
i) said medium is adopted for coupling with an external audio reproducing system,

2. A communicating audio system of claim 1 wherein said tunable means include switches for increasing and decreasing said audio signals and for selecting a preferred operating network.

3. A communicating audio system of claim 1 wherein said crossover network has an input port for microphone input signals and said microphone signals can be tuned by said tunable means while transmitting said audio signals.

4. A communicating audio system of claim 2 wherein said tunable means is able to tune a receiving signal entering said receiving section.

5. A communicating audio system of claim 1 wherein said audio transmitting section is an audio section for transmitting said audio signal to a remote receiver for broadcasting to a user.

6. A communicating audio system of claim 1 wherein said medium conducts audio signals from said output port to said external audio reproducing system whereby said system is able to control said signals distinctively.

7. A communicating audio system of claim 1 wherein said receiving section is a audio section for receiving audio signals.

8. A method of communicating and coupling externally using an electronic medium
a) providing a first connecting means which is able to dispose into a first audio port and communicate with said first audio port,
b) providing at least one wire-conductor which is able to conduct audio signals from said first connecting means,
c) providing a second connecting means at the opposite end of said wire-conductor for disposing into a second audio port and communicating said audio signals to an external audio reproducing system,

9. A coupling method of claim 8 wherein said first connecting means is a audio plug adopted for disposing into said first audio port.

10. A coupling method of claim 8 wherein said second connecting means is a second audio plug adopted for disposing into said second audio port.

11. A coupling method of claim 8 wherein said conductor-wire is a pies of acoustic wire material adopted for conducting audio signals initializing from said first connecting means.

12. A coupling method of claim 8 wherein said first audio port and said second audio port are external audio terminals for coupling externally from a audio receiving section to the distinct reproductive audio system.

13. A coupling method of claim 8 wherein said reproducing audio system is the acoustic system in a motor vehicle which is able to control said audio signals initializing from said second connecting means.

14. A coupling method of claim 8 wherein said first audio port is located on a communication apparatus.

15. A coupling method of claim 8 wherein said second audio port is located on said reproducing audio system.
